(19) United States
(12) Patent Application Publication
(10) Pub. No.: US 2010/0141371 A1
(43) Pub. Date: Jun. 10, 2010

(54) Magnetic Core-Coil Device and Method for Making the Same

(75) Inventor: Wan-Hsun Wang, Hsinchu County (TW)

Correspondence Address: DLA PIPER LLP (US ), 2000 UNIVERSITY AVENUE, EAST PALO ALTO, CA, 94303-2248, US

(73) Assignees: Shih-Jen Wang, Hsinchu County (TW); Meng-Hua Hsien, Hsinchu County (TW); Ya-Ting Wang, Hsinchu County (TW)

(21) Appl. No.: 12/707,590

(22) Filed: Feb. 17, 2010

Related U.S. Application Data
(63) Continuation-in-part of application No. 11/717,508, filed on Mar. 12, 2007.

(30) Foreign Application Priority Data
Dec. 16, 2009 (TW) 098143110

(51) Int. Cl. H01F 5/02; H01F 41/02

(52) U.S. Cl. 336/200; 29/606

(57) ABSTRACT

A magnetic core-coil device includes: a printed circuit board having a stack of plate layers, a loop-shaped magnetic core, a primary winding, and an auxiliary winding. The loop-shaped magnetic core has two side portions extending through two rows of through holes of the printed circuit board. The primary winding includes a plurality of primary coil sections formed respectively on the plate layers and each looping around one of the side portions. The auxiliary winding includes a plurality of auxiliary coil sections formed respectively on the plate layers and each looping around the other one of the side portions.

A method for making the magnetic core-coil device is also disclosed.

### CROSS-REFERENCE TO RELATED APPLICATION

This application is a continuation-in-part (CIP) of U.S. patent application Ser. No. 11/717,508, filed on Mar. 12, 2007, and claims priority of Taiwanese application no. 098143110, filed on Dec. 16, 2009.

### BACKGROUND OF THE INVENTION

1. Field of the Invention

This invention relates to a magnetic core-coil device and a method for making the same, more particularly to a magnetic core-coil device formed in a printed circuit board, and a method for making the same.

2. Description of the Related Art

A magnetic core-coil device mainly includes a loop-shaped magnetic core and at least one winding looping around the loop-shaped magnetic core. Because such magnetic core-coil device is magnetically inducible, it can be used in transformers, chokes, or network transformers that can function as a transformer and a choke simultaneously. A network transformer is described as follows.

Referring to FIG. 1, there are shown multiple network transformers 1 (i.e., magnetic core-coil devices) each including two loop-shaped magnetic cores 11 and two windings 12 respectively looping around the magnetic cores 11. For packaging with an electronic device, these network transformers 1 are first installed on a lead frame 13 by a manual operation, followed by manually soldering the windings 12 of the network transformers 1 to respective legs of the lead frame 13.

Since the network transformers 1 are installed on the lead frame 13 manually, non-uniform distances among adjacent ones of the network transformers 1 and misalignment of the network transformers 1 can result, thereby leading to undesired noise and magnetic loss during operation of the electronic device.

### SUMMARY OF THE INVENTION

An object of the present invention is to provide a magnetic core-coil device and a method for making the same, both of which can overcome the aforesaid drawbacks associated with the prior art.

According to one aspect of this invention, there is provided a magnetic core-coil device that comprises:

a printed circuit board having a stack of plate layers, each of which is formed with a pair of first through holes that are spaced apart from each other, the first through holes in the stack of the plate layers being aligned with each other to form two rows of the first through holes;

a first loop-shaped magnetic core having two first side portions respectively extending through the two rows of the first through holes, a first top connecting portion formed on a top surface of a topmost one of the plate layers and bridging the first side portions, and a first bottom connecting portion formed on a bottom surface of a bottommost one of the plate layers and bridging the first side portions;

a primary winding including a plurality of primary coil sections stacked one above the other and electrically connected to each other in series connection, the primary coil sections being formed respectively on the plate layers and each looping around one of the first side portions; and
an auxiliary winding including a plurality of auxiliary coil sections stacked one above the other and electrically connected to each other in series connection, the auxiliary coil sections being formed respectively on the plate layers and each looping around the other one of the first side portions.

According to another aspect of this invention, there is provided a method for making a magnetic core-coil device that comprises:

(a) providing a printed circuit board having a stack of plate layers, each of which is formed with a pair of through holes that are spaced apart from each other, the through holes in the stack of the plate layers being aligned with each other to form two rows of the through holes;

(b) providing a loop-shaped magnetic core having two first side portions respectively extending through the two rows of the through holes, a top connecting portion formed on a top surface of a topmost one of the plate layers and bridging the side portions, and a bottom connecting portion formed on a bottom surface of a bottommost one of the plate layers and bridging the side portions;

(c) providing a primary winding including a plurality of primary coil sections stacked one above the other and electrically connected to each other in series connection, the primary coil sections being formed respectively on the plate layers and each looping around one of the side portions; and

(d) providing an auxiliary winding including a plurality

Of auxiliary coil sections stacked one above the other and electrically connected to each other in series connection, the auxiliary coil sections being formed respectively on the plate layers and each looping around the other one of the side portions.

### BRIEF DESCRIPTION OF THE DRAWINGS

Other features and advantages of the present invention will become apparent in the following detailed description of the preferred embodiments of the invention, with reference to the accompanying drawings, in which:

FIG. 1 is a top view of a conventional magnetic core-coil device;

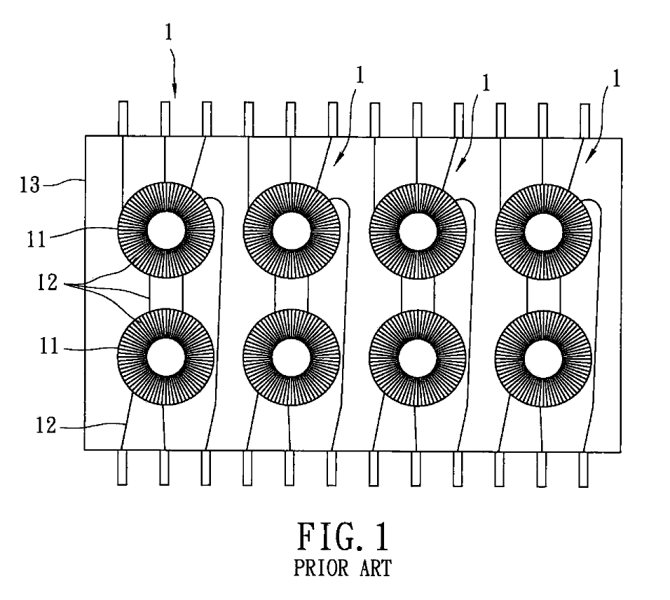

FIG. 2 is a perspective view of the first embodiment of a magnetic core-coil device according to the present invention;

FIG. 3 is a top view of the magnetic core-coil device of FIG. 2;

FIG. 4 is an exploded view of first to third plate layers in the magnetic core-coil device of FIG. 2;

FIG. 5 is an exploded view of fourth to eighth plate layers in the magnetic core-coil device of FIG. 2;

FIG. 6 is a fragmentary schematic sectional view illustrating a mold to manufacture the magnetic core-coil device according to the first embodiment of the present invention;

FIG. 7 is the same view as FIG. 6 but illustrating that the mold is closed;

FIG. 8 is an exploded view of the magnetic core-coil device according to the second embodiment of the present invention; and

FIG. 9 is a perspective view of the third embodiment of magnetic core-coil devices according to the present invention.

### DETAILED DESCRIPTION OF THE PREFERRED EMBODIMENTS

Before the present invention is described in greater detail with reference to the accompanying preferred embodiments, it should be noted herein that like elements are denoted by the same reference numerals throughout the disclosure.

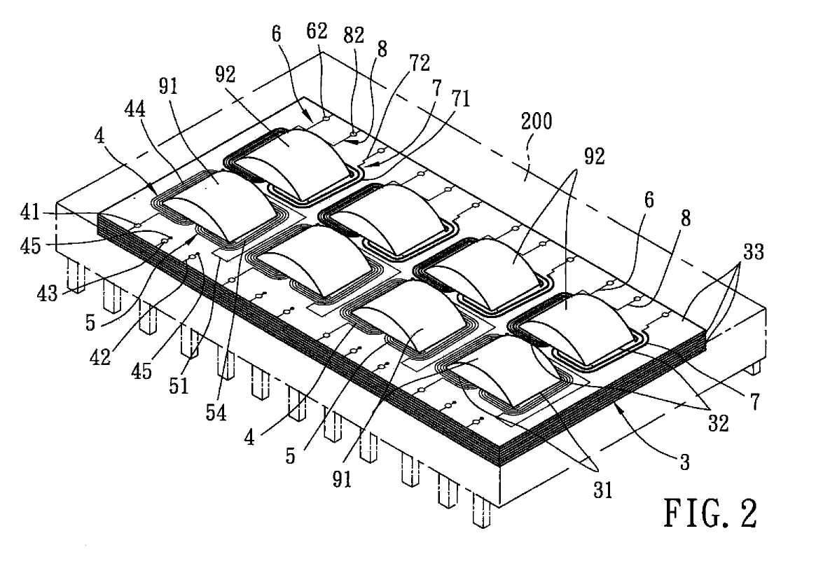

Based on the design, a plurality of magnetic core-coil device can be provided a lead frame. As shown in FIG. 2, four sets of the magnetic core-coil devices are mounted on a printed circuit board 3 which in turn is provided on the lead frame 200. For the sake of simplicity, only one set of the magnetic core-coil devices is described hereinafter.

Referring to FIGS. 2 to 5, each set of the magnetic core-coil devices includes a primary winding 4, an auxiliary winding 5, a first winding 5, a second winding 7, a third winding 8, a first loop-shaped magnetic core 91, and a second loop-shaped magnetic core 92.

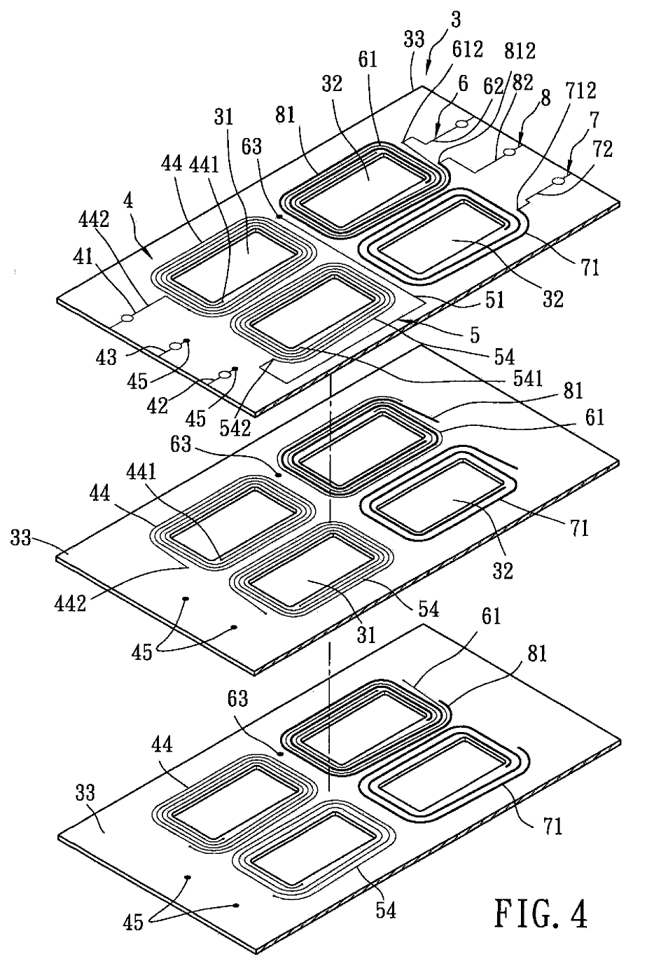

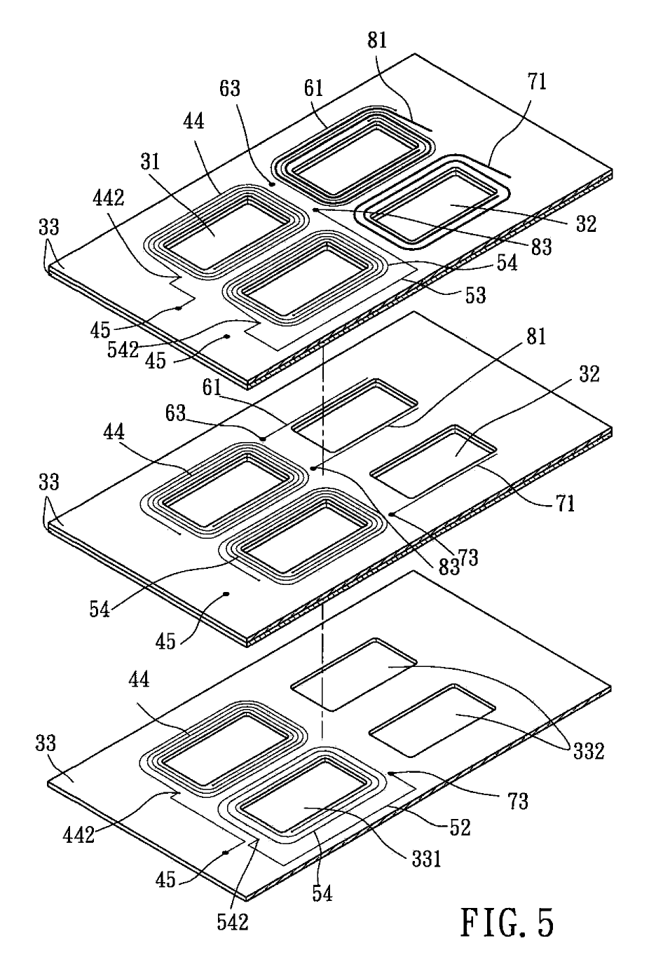

The printed circuit board 3 has a stack of plate layers 33, specifically, eight plate layers 33 as shown in FIGS. 4 and 5.

Each of the plate layers 33 is formed with a pair of first through holes 31 that are spaced apart from each other. The first through holes 31 in the stack of the plate layers 33 are aligned with each other to form two rows of the first through holes 31.

Each of the plate layers 33 is further formed with a pair of second through holes 32 that are spaced apart from each other. The second through holes 32 in the stack of the plate layers 33 are aligned with each other to form two rows of the second through holes 32.

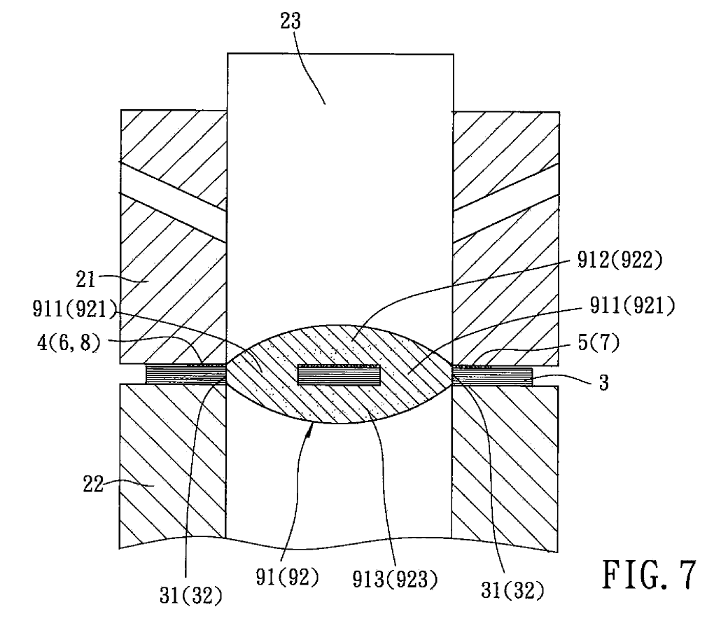

The first loop-shaped magnetic core 91 has two first side portions 911, a first top connecting portion 912, and a first bottom connecting portion 913 (see FIG. 7). The first side portions 911 respectively extend through the two rows of the first through holes 31. The first top connecting portion 912 is formed on a top surface of a topmost one of the plate layers 33 and bridges the first side portions 911. The first bottom connecting portion 913 is formed on a bottom surface of a bottommost one of the plate layers 33 and bridges the first side portions 911.

The second loop-shaped magnetic core 92 has two second side portions 921, a second top connecting portion 922, and a second bottom connecting portion 923 (see FIG. 7). The second side portions 921 respectively extend through the two rows of the second through holes 32. The second top connecting portion 922 is formed on the top surface of the topmost one of the plate layers 33 and bridges the second side portions 921. The second bottom connecting portion 923 is formed on the bottom surface of the bottommost one of the plate layers 33 and bridges the second side portions 921.

The primary winding 4 includes first, second, and third terminal lines 41, 42, 43, a plurality of primary coil sections 44, and two rows of primary conductive via holes 45 formed in the printed circuit board 3. All of the first, second, and third terminal lines 41, 42, 43 are formed on the topmost plate layer 33.

The primary coil sections 44 are stacked one above the other. Each of the primary coil sections 44 is formed on one of the plate layers 33 and loops around one of the first through holes 31 of said one of the plate layers 33. In other words, each of the primary coil sections 44 loops around one of the first side portions 911 (see FIG. 7).

Each of the primary coil sections 44 has a coil inner end 441 and a coil outer end 442. Except for the primary coil section 44 on the bottommost one of the plate layers 33, at least one of the coil inner and outer ends 441, 442 in one of the plate layers 33 penetrates the respective one of the plate layers 33 for electrical connection with an adjacent one of the primary coil sections 44. Therefore, the primary coil sections 44 are electrically connected to each other in series connection.

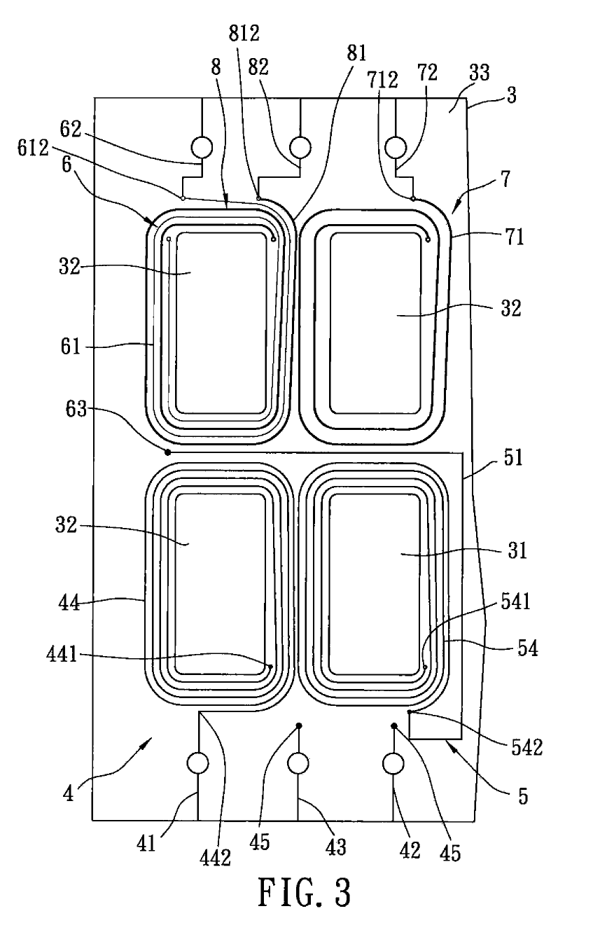

The first terminal line 41 is electrically connected to the coil outer end 442 of the topmost primary coil section 44 on the topmost one of the plate layers 33, as best shown in FIG. 3.

The second terminal line 42 is electrically connected to the coil outer end 442 of the bottommost primary coil section 44 on the bottommost one of the plate layers 33 through one row of the primary conductive via holes 45, as best shown in FIG. 5.

The third terminal line 43 is electrically connected to the coil outer end 442 of the primary coil secₜion 44 on the fourth plate layer 33 through another row of the primary conductive via holes 45, as best shown in FIG. 5.

In this embodiment, each primary coil section 44 loops around one of the first side portions 911 with four turns. Therefore, there are sixteen turns of coil between the first and second terminal lines 41, 42 and between the second and third terminal lines 42, 43.

The auxiliary winding 5 is similar to the primary winding 4, and includes first, second, and third output terminal lines 51, 52, 53, and a plurality of auxiliary coil sections 54.

The auxiliary coil sections 54 are stacked one above the other. Each of the auxiliary coil sections 54 is formed on one of the plate layers 33 and loops around the other one of the first through holes 31 of said one of the plate layers 33. In other words, each of the auxiliary coil sections 54 loops the other one of the first side portions 911 (see FIG. 7).

The auxiliary coil sections 54 are electrically connected to each other in series connection by the same manner as the primary coil sections 44. Each of the auxiliary coil sections 54 has a coil inner end 541 and a coil outer end 542.

The first output terminal line 51 is formed on the topmost plate layer 33 and is electrically connected to the coil outer end 542 of the auxiliary coil section 54 on the topmost plate layer 33, as best shown in FIG. 3.

The second output terminal line 52 is formed on the bottommost plate layer 33 and is electrically connected to the coil outer end 542 of the auxiliary coil section 54 on the bottommost plate layer 33, as best shown in FIG. 5.

The third output terminal line 53 is formed on ₜhe fourth plate layer 33 and is electrically connected to the coil outer end 542 of the auxiliary coil section 54 on the fourth plate layer 33, as best shown in FIG. 5.

In this embodiment, each auxiliary coil section 54 loops around the other one of the first side portions 911 with three or four turns. Preferably, there are fifteen turns between the first and second output terminal lines 51, 52 and between the second and third output terminal lines 52, 53.

In practice, the number of turns for the primary and auxiliary coil sections 44, 54 on each of the plate layers 33 can be varied based on the design.

The first winding 6 includes a plurality of first coil sections 61, a fourth terminal line 62, and a row of first conductive via holes 63.

The first coil sections 61 are stacked one above the other. The first coil sections 61 are formed on some of the plate layers 33 other than the seventh and eighth plate layers 33, and each loops around one of the second through holes 32 in one of the plate layers 33. In other words, each of the first coil sections 61 loops around one of the second side portions 921 (see FIG. 7).

The first coil sections 61 are electrically connected to each other in series connection by the same manner as the primary coil sections 44.

The fourth terminal line 62 is formed on the topmost one of the plate layers 33 and is electrically connected to a coil outer end 612 of the first coil section 61 on the topmost one of the plate layers 33, as best shown in FIG. 3.

The row of first conductive via holes 63 electrically connects the first winding 6 (i.e., the first coil section 61 on the sixth plate layer 33) to the first output terminal line 51 on the topmost plate layer 33.

The second winding 7 includes a plurality of second coil sections 71, a fifth terminal line 72, and a row of second conductive via holes 73.

The second coil sections 71 are stacked one above the other. The second coil sections 71 are formed on some of the plate layers 33 other than the seventh and eighth plate layers 33, and each loops around the other one of the second through holes 32 of one of the plate layers 33. In other words, each of the second coil sections 71 loops around the other one of the second side portions 921 (see FIG. 7).

The second coil sections 71 are electrically connected to each other in series connection by the same manner as the primary coil sections 44.

The fifth terminal line 72 is formed on the topmost one of the plate layers 33 and is electrically connected to a coil outer end 712 of the second coil section 71 on the topmost one of the plate layers 33, as best shown in FIG. 3.

The row of second conductive via holes 73 electrically connects the second winding 7 (i.e., the second coil section 71 on the sixth plate layer 33) to the second output terminal line 52 on the bottommost (eighth) plate layer 33, as best shown in FIG. 5.

The third winding 8 includes a plurality of third coil sections 81, a sixth terminal line 82, and a row of third conductive via holes 83.

The third coil sections 81 are stacked one above the other. The third coil sections 81 are formed on some of the plate layers 33 other than the seventh and eighth plate layers 33, and each loops around one of the second through holes 32 in one of the plate layers 33. In other words, each of the third coil sections 81 loops around said one of the second side portions 921 (see FIG. 7).

The third coil sections 81 are electrically connected to each other in series connection by the same manner as the primary coil sections 44.

The sixth terminal line 82 is formed on the topmast one of the plate layers 33 and is electrically connected to a coil outer end 812 of the third coil section 81 on the topmost one of the plate layers 33, as best shown in FIG. 3.

The row of third conductive via holes 83 electrically connects the third winding 8 (i.e., the third coil section 81 on the sixth plate layer 33) to the third output terminal line 53 on the fourth plate layer 33, as best shown in FIG. 5.

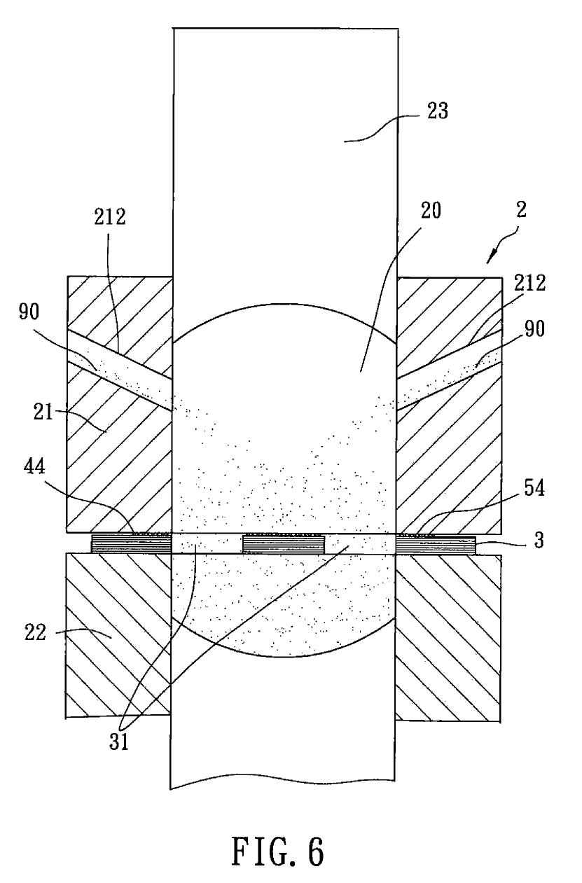

The first embodiment of the method for making the magnetic core-coil device according to the present invention will be described hereinafter with reference to FIGS. 6 and 7.

In step (i), the printed circuit board 3 formed with two rows of the first through holes 31 and two rows of the second through holes 32 (see FIGS. 2-5) is provided.

In step (ii), the primary winding 4, the auxiliary winding 5, and the first, second and third windings 6, 7, 8 (see FIGS. 4 and 5) are provided on the printed circuit board 3.

In step (iii), as shown in FIGS. 6 and 7, each of the first and second loop-shaped magnetic cores 91, 92 is fabricated by:

(1) placing a portion of the printed circuit board 3 that includes the rows of the through holes 31 (32) in a mold cavity 20 between upper and lower mold parts 21, 22 of a mold 2;

(2) moving down the upper mold part 21 toward the lower mold part 22 to close the mold cavity 20, and introducing a magnetic material 90 into the mold cavity 20 through runners 212 of the upper mold part 21; and

(3) moving a plunger 23 of the upper mold part 21 into the mold cavity 20 to compression mold the magnetic material 90 over the portion of the printed circuit board 3.

In this embodiment, the magnetic material 90 is magnetic powder.

In other embodiments, the magnetic material 90 is magnetic polymer material. Each of the first and second loop-shaped magnetic cores 91, 92 is fabricated by: placing the portion of the printed circuit board 3 in a mold cavity of an injection mold (not shown); and injection molding to form the loop-shaped magnetic cores 91, 92 over the portion of the printed circuit board.

After the above steps, a plurality of magnetic core-coil devices are disposed on the lead frame 200, and are subsequently packaged to form an electronic device.

In this embodiment, the magnetic core-coil device is used for a network transformer. Signals and currents are inputted using the first, second and third terminal lines 41, 42, 43 of the primary winding 4. Output signals and currents of the auxiliary winding 5 induced by the primary winding 4 are transferred to the first, second and third windings 6, 7, 8 before being outputted. Hence, AC signals and high-frequency noise in the output signals and currents can be attenuated by the first, second and third windings 6, 7, 8.

By providing the primary winding 4, the auxiliary winding 5, and the first, second and third windings 6, 7, 8 with multiple coil sections 44, 54, 61, 71 or 81, the locations and sizes of the windings 4, 5, 6, 7 and 8 can be well controlled. In addition, as the loop-shaped magnetic cores 91, 92 are molded directly over the printed circuit board 3, no clearance is produced between the printed circuit board 3 and the loop-shaped magnetic cores 91 or 92, thereby avoiding vibrations, noise, magnetic loss, etc. Therefore, the drawbacks associated with the prior art can be eliminated.

Alternatively, the coil sections 44, 54, 61, 71, or 81 in each of the primary winding 4, the auxiliary winding 5, and the first, second and third windings 6, 7, 8 can be formed on every other plate layer 33, rather than every plate layer 33, and can be interconnected using the row of conductive via holes 45, 63, 73, or 83.

When the magnetic core-coil device is dispensed with the third terminal line 43 of the primary winding 4, the third output terminal line 53 of the auxiliary winding 5, and the third winding 8, the magnetic core-coil device can be used as an electronic device that has combined functions of a transformer and a choke.

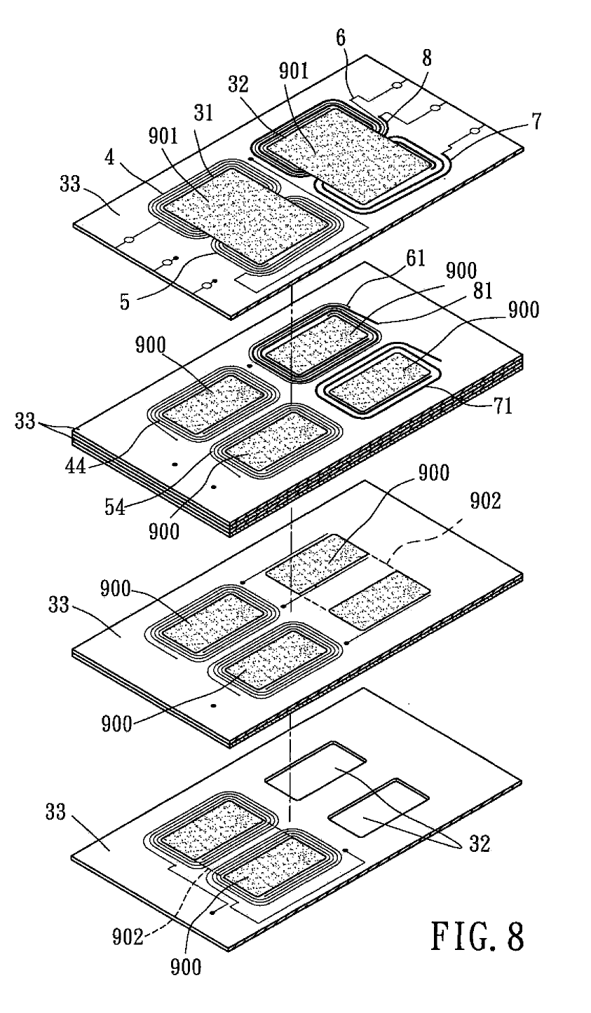

The second embodiment of the method for making the magnetic core-coil device according to the present invention will be described hereinafter with reference to FIG. 8. The second embodiment differs from the first embodiment only in that, in the step (iii), the first and second loop-shaped magnetic cores 91, 92 of the second embodiment are fabricated by:

(1) filling a magnetic material into and thereby forming a core layer 900 in each of the first and second through holes 31, 32;

(2) forming a top connecting layer 901 of the magnetic material on the top surface of the topmost one of the plate layers 33 to bridge the core layers 900 in each pair of the through holes 31, 32 in the topmost one of the plate layers 33;

(3) forming a bottom connecting layer 902 of the magnetic material on the bottom surface of each of the sixth one of the plate layers 33 and the bottommost one of the plate layers 33 to bridge the core layers 900 in the pair of the through holes 31 or 32 in the sixth one of the plate layers 33 and the bottommost one of the plate layers 33; and

(4) stacking the core layers 900 and the connecting layers 901, 902 of the magnetic material.

Preferably, the core layers 900 and the connecting layers 901, 902 are formed by the printing process in which the magnetic material is printed in multiple layers onto each plate layer 33 until a predetermined thickness is reached.

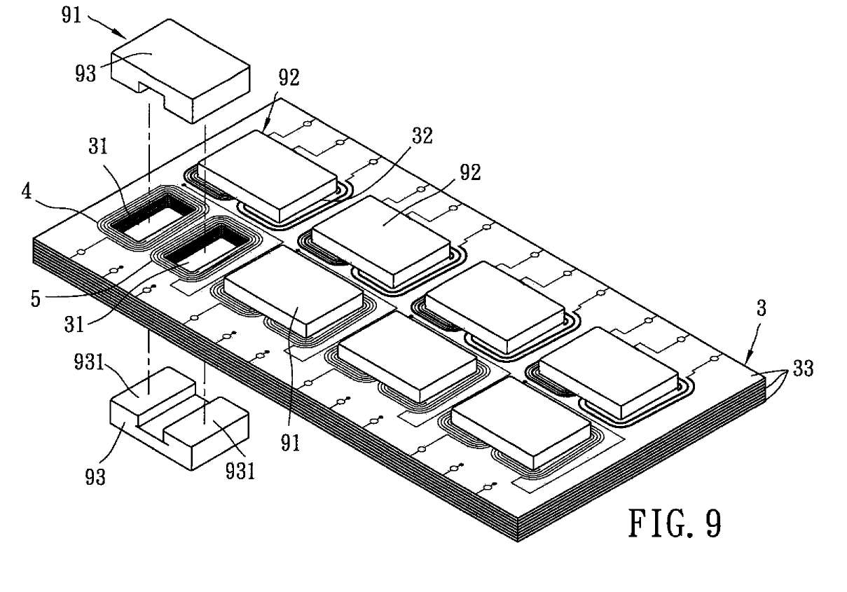

The third embodiment of the method for making the magnetic core-coil device according to the present invention will be described hereinafter with reference to FIG. 9. The third embodiment differs from the first embodiment only in that, in the step (iii), each of the first and second loop-shaped magnetic cores 91, 92 of the second embodiment is fabricated by:

(1) forming two substantially U-shaped core halves 93 each having two insert ends 931;

(2) inserting the core halves 93 respectively from top and bottom sides of the printed circuit board 3 such that the two insert ends 931 of each of the core halves 93 are respectively inserted into the two rows of the through holes 31 or 32; and

(3) abutting the core halves 93 against each other such that the printed circuit board 3 is clamped between the core halves 93.

While the present invention has been described in connection with what are considered the most practical and preferred embodiments, it is understood that this invention is not limited to the disclosed embodiments but is intended to cover various arrangements included within the spirit and scope of the broadest interpretations and equivalent arrangements.

What is claimed is:

1. A magnetic core-coil device comprising:
a printed circuit board having a stack of plate layers, each of which is formed with a pair of first through holes that are spaced apart from each other, said first through holes in said stack of said plate layers being aligned with each other to form two rows of said first through holes;
a first loop-shaped magnetic core having two first side portions respectively extending through said two rows of said first through holes, a first top connecting portion formed on a top surface of a topmost one of said plate layers and bridging said first side portions, and a first bottom connecting portion formed on a bottom surface of a bottommost one of said plate layers and bridging said first side portions;
a primary winding including a plurality of primary coil sections stacked one above the other and electrically connected to each other in series connection, said primary coil sections being formed respectively on said plate layers and each looping around one of said first side portions; and
an auxiliary winding including a plurality of auxiliary coil sections stacked one above the other and electrically connected to each other in series connection, said auxiliary coil sections being formed respectively on said plate layers and each looping around the other one of said first side portions.

2. The magnetic core-coil device of claim 1, wherein each of said plate layers is further formed with a pair of second through holes that are spaced apart from each other, said second through holes in said stack of said plate layers being aligned with each other to form two rows of said second through holes; and
wherein said magnetic core-coil device further comprises:
a second loop-shaped magnetic core having two second side portions respectively extending through said two rows of said second through holes, a second top connecting portion formed on said top surface of said topmost one of said plate layers and bridging said second side portions, and a second bottom connecting portion formed on said bottom surface of said bottommost one of said plate layers and bridging said second side portions; and
a first winding including a plurality of first coil sections which are stacked one above the other and which are electrically connected to each other in series connection, said first coil sections being formed respectively on at least some of said plate layers and each looping around one of said second side portions.

3. The magnetic core-coil device of claim 2, further comprising a second winding including a plurality of second coil sections stacked one above the other and electrically connected to each other in series connection, said second coil sections being formed respectively on at least some of said plate layers and each looping around the other one of said second side portions; and
wherein a topmost one of said auxiliary coil sections is electrically connected to one end of said first winding, and a bottommost one of said auxiliary coil sections is electrically connected to one end of said second winding.

4. The magnetic core-coil device of claim 3, wherein said primary winding further includes:
first and second terminal lines that are formed on said topmost one of said plate layers, and that are respectively and electrically connected to topmost and bottommost ones of said primary coil sections; and
a third terminal line formed on said topmost one of said plate layers and electrically connected to one of said primary coil sections between said topmost and bottommost ones of said primary coil sections.

5. The magnetic core-coil device of claim 4, wherein said auxiliary winding further includes: first and second output terminal lines that are respectively formed on said topmost and bottommost ones of said plate layers, and a third output terminal line formed on one of said plate layers between said topmost and bottommost ones of said plate layers and electrically connected to one of said auxiliary coil sections between said topmost and bottommost ones of said auxiliary coil sections, said first output terminal lines being electrically connected to said topmost one of said auxiliary Coil sections and said one end of said first winding, said second output terminal lines being electrically connected to a bottommost one of said second coil sections and said one end of said second winding.

6. The magnetic core-coil device of claim 5, further comprising a third winding including a plurality of third coil sections, which are stacked one above the other and which are electrically and respectively connected to one another in series connection, said third coil sections being formed respectively on at least some of said plate layers and each looping around said one of said second side portions of said second loop-shaped magnetic core, said third output terminal line being further electrically connected to one end of said third winding.

7. The magnetic core-coil device of claim 6, wherein:
each of said primary, auxiliary, first, second and third windings has one of said coil sections disposed on said topmost one of said plate layers;
said first winding further includes a fourth terminal line electrically connected to another end of said first winding;
said second winding further includes a fifth terminal line electrically connected to another end of said second winding;
said third winding further includes a sixth terminal line electrically connected to another end of said third winding; and
all of said first, second, third, fourth, fifth, and sixth terminal lines are formed on said topmost one of said plate layers.

8. magnetic core-coil device of claim 7, wherein said primary winding further includes: a row of primary conductive via holes formed in said printed circuit board and electrically connected between said second terminal line and said primary winding; and another row of primary conductive via holes formed in said printed circuit board and electrically connected between said third terminal line and said primary winding.

9. The magnetic core-coil device of claim 8, wherein:
said first winding further includes a row of first conductive via holes formed in said printed circuit board and electrically connecting said first winding to said first output terminal line;
said second winding further includes a row of second conductive via holes formed in said printed circuit board and electrically connecting said second winding to said second output terminal line; and
said third winding further includes a plurality of third conductive via holes formed in said printed circuit board and electrically connecting said third winding to said third output terminal line.

10. A method for making a magnetic core-coil device, comprising:
(a) providing a printed circuit board having a stack of plate layers, each of which is formed with a pair of through holes that are spaced apart from each other, the through holes in the stack of the plate layers being aligned with each other to form two rows of the through holes;
(b) providing a loop-shaped magnetic core having two side portions respectively extending through the two rows of the through holes, a top connecting portion formed on a top surface of a topmost one of the plate layers and bridging the side portions, and a bottom connecting portion formed on a bottom surface of a bottommost one of the plate layers and bridging the side portions;
(c) providing a primary winding including a plurality of primary coil sections stacked one above the other and electrically connected to each other in series connection, the primary coil sections being formed respectively on the plate layers and each looping around one of the side portions; and
(d) providing an auxiliary winding including a plurality of auxiliary coil sections stacked one above the other and electrically connected to each other in series connection, the auxiliary coil sections being formed respectively on the plate layers and each looping around the other one of the side portions.

11. The method of claim 10, wherein the loop-shaped magnetic core is fabricated by placing a portion of the printed circuit board that includes the rows of the through holes in a mold cavity and introducing a magnetic material into the mold cavity to mold the magnetic material over the printed circuit board.

12. The method of claim 10, wherein the loop-shaped magnetic core is fabricated by: filling a magnetic material into and thereby forming a core layer in each of the through holes; forming a top connecting layer of the magnetic material on the top surface of the topmost one of the plate layers to bridge the core layers in the topmost one of the plate layers; forming a bottom connecting layer of the magnetic material on the bottom surface of the bottommost one of the plate layers to bridge the core layers in the bottommost one of the plate layers; and stacking the core layers and the connecting layers of the magnetic material.

13. The method of claim 12, wherein the steps of filling the magnetic material into the through holes and forming the connecting layers of the magnetic material are conducted by a printing process.

14. The method of claim 10, wherein the loop-shaped magnetic core is fabricated by forming two substantially U-shaped core halves, inserting the core halves into the rows of the through holes respectively from top and bottom sides of the printed circuit board, and abutting the core halves against each other such that the printed circuit board is clamped between the core halves.
